(19) United States
(12) Patent Application Publication
(10) Pub. No.: US 2014/0012612 A1
(43) Pub. Date: Jan. 9, 2014

(54) VISUALIZATION OF WAREHOUSE OPERATIONS FORECAST

(71) Applicants: Mirza Abdic, Copenhegan (DK); Ievgenii Korovin, Copenhegan (DK); Maciej Plaza, Copenhegan (DK); Maciej Krzysztof Zarzycki, Copenhegan (DK); Oleksandr Moskalyuk, Copenhegan (DK)

(72) Inventors: Mirza Abdic, Copenhegan (DK); Ievgenii Korovin, Copenhegan (DK); Maciej Plaza, Copenhegan (DK); Maciej Krzysztof Zarzycki, Copenhegan (DK); Oleksandr Moskalyuk, Copenhegan (DK)

(73) Assignee: MICROSOFT CORPORATION, Redmond, WA (US)

(21) Appl. No.: 13/540,617

(22) Filed: Jul. 3, 2012

(51) Int. Cl. G06Q 10/08

(52) U.S. Cl. 705/7.12

(57) ABSTRACT

A computer implemented warehouse operations forecasting system includes a series of user navigable displays hierarchically organized based on level of detail from more general to more detailed in terms of information presented. One of the displays in the series includes an indication of projected warehouse space utilization over a period of time in the future.

### BACKGROUND

A forecast of near-future warehouse operations makes it easier to effectively manage people and space resources. Such a forecast enables a warehouse manager to anticipate the impact of various activity scenarios across the whole company upon the manager's primary area of responsibility—namely all things warehouse. When such impacts are anticipated, they can easily be accounted for in the decision making processes of the manager and others responsible for making warehouse related decisions.

Currently, at least some enterprise resource planning systems support the retrieval of data sets that can be utilized to support the creation of at least a limited forecast of near-future warehouse operations. However, creation of an effective forecast generally requires cross-analysis of data sets from multiple, often times many, data sources. Further, the data sets are commonly substantial in size. Thus, it is generally not easy to efficiently generate a forecast that is an effective tool for informing warehouse management decisions.

The discussion above is merely provided for general background information and is not intended to be used as an aid in determining the scope of the claimed subject matter.

### SUMMARY

A computer implemented warehouse operations forecasting system includes a series of user navigable displays hierarchically organized based on level of detail from more general to more detailed in terms of information presented. One of the displays in the series includes an indication of projected warehouse space utilization over a period of time in the future.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagram of one illustrative warehouse operations forecasting system.

FIG. 2 is a flow diagram demonstrating a series of steps that are part of a process for generating a warehouse operations forecast.

FIGS. 3-14 are illustrative user interface displays generated and presented to a user of the warehouse operations forecasting system.

FIG. 15 is a block diagram representation of one illustrative cloud computing architecture.

FIGS. 16-19 are illustrative examples of mobile devices.

FIG. 20 is a block diagram of one embodiment of a computing environment.

### DETAILED DESCRIPTION

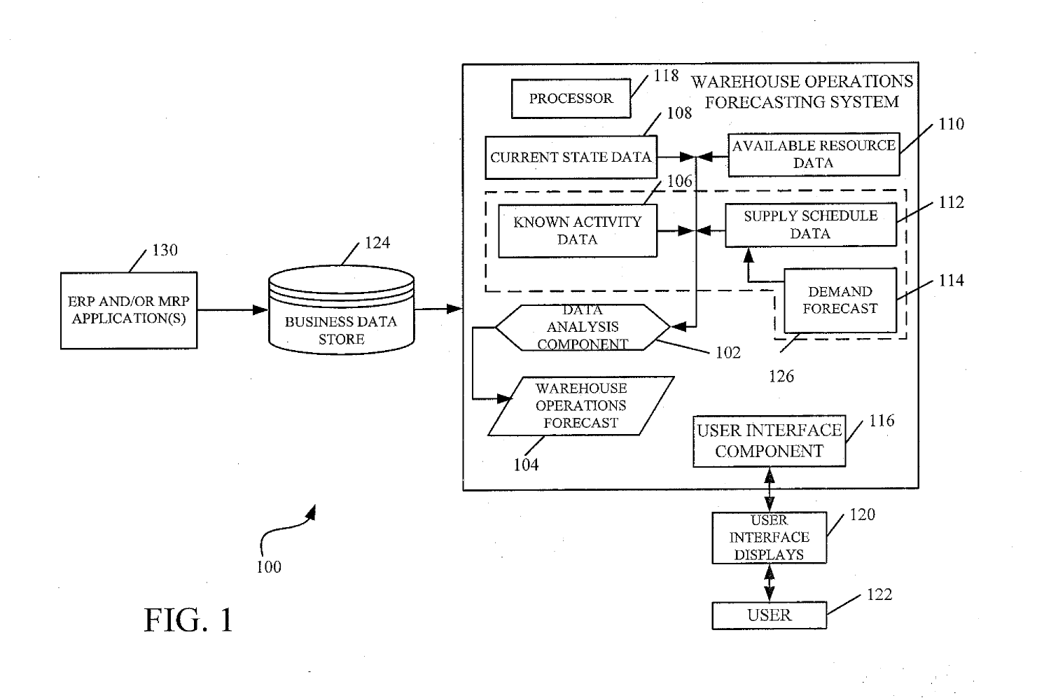

FIG. 1 is a block diagram of one embodiment of a warehouse operations forecasting system 100. It should be noted that forecasting system 100 may be implemented with or as part of a larger business data system, such as an enterprise resource planning (ERP) system, a manufacturing or materials or master resource planning (MRP) system, a combination ERP/MRP system, a book keeping system, or other business data system. The scope of the present invention is not limited to any particular distributed or unified implementation context or configuration.

In one embodiment, forecasting system 100 includes a data analysis component 102 configured with software code that, when executed by a processor 118, triggers the generation of a warehouse operations forecast 104 based at least in part on programmatic analysis of one or more of data sets 106, 108, 110, 112 and 114. These particular data sets are specifically identified for illustrative purposes, however, it is within the scope of the present invention for forecast 104 to factor any combination of business operations data into the generation of forecast 104, including types of data that are not necessarily identified specifically in FIG. 1.

Forecasting system 100 also includes a user interface component 116 that utilizes processor 118 to generate user interface displays 120, which are presented to a user 122. In one embodiment, but not by limitation, the warehouse operations forecast 104 is presented to user 122 as part of displays 120. Those skilled in the art will appreciate that, in one illustrative embodiment, component 116 is used to map information 104 into user interface displays 120 rather than display information 104 directly. Further, user interface displays 120 (including the forecast 104) are selectively configured and presented in correlation to user inputs received from user 122 by way of any of a variety of different user input mechanisms (not shown specifically in FIG. 1 but will be discussed below in relation to other Figures).

The processor 118 is illustratively a computer processor with associated timing and memory circuitry (circuitry not shown specifically in FIG. 1). The processor 118 illustratively facilitates the functionality not just of data analysis component 102 but also manages the execution of other functionality associated with the various components of forecasting system 100. Examples of computing devices and systems having processors with which forecasting system 100 and other embodiments of the present invention may be implemented will also be described below in relation to other Figures.

In the embodiment shown in FIG. 1, the warehouse operations forecasting system 100 is shown as being coupled to a business data store 124 that stores any of a variety of different types of business data, such as (but not limited to) records of invoices, purchase orders, general ledger entries, inventory data, etc. The data store 124 illustratively may be a source from which all or some of known activity data 106, current state data 108, available resource data 110, supply schedule data 112 and the demand forecast 114 are derived. Of course, some or all of this data may be stored in other data stores inside and/or outside the natural or theoretical boundaries of forecasting system 100 without departing from the scope of the present invention. Further, it is of course true that these different types of data need not necessarily be derived from a single source but instead may be derived from a plurality of different, separate data sources. A single data source is shown in FIG. 1 only for the purposes of simplifying the Figure for illustrative purposes.

In one embodiment, one or more of data sets 106-114 are derived from data generated by (or otherwise maintained in association with) one or more ERP and/or MRP applications 130. The ERP and MRP applications may or may not have any integrated warehouse management functionality. For example, in one embodiment, at least the data sets 106, 112 and 114 included within dotted line 126 are illustratively derived from an ERP and/or an MRP application where the data is tracked for the purpose of supporting ERP and/or MRP application functions not necessarily directly or specifically related to warehouse management.

In one embodiment, the warehouse operations forecast 104 generated by component 102 is a projected overview of what the status of warehouse operations and resources will be in the future following an execution of business activities in accordance with parameters defined in data sets 106-114. In another embodiment, some data records included in data sets 106-114 may be different versions of the “same” record (e.g., the data in each version is different but both versions have the same business purpose, such as two different annual sales projections for the same year). In these circumstances, multiple forecasts 104 can be selectively generated by data analysis component 102 such that different versions of the forecast 104 reflect calculative reliance upon the different versions of the same data set. Each version of the forecast 104 is illustratively based on a different combination of underlying data sets, the determination of which data sets are utilized by component 102 to generate each forecast 104 being a function of automatic programmatic execution of system parameters and/or based at least in part on commands received from user 122. In one embodiment, some or all of the data sets factored by component 102 into the warehouse operations forecast 104 are simulated data sets (e.g., a data set(s) provided on a “what if” basis) such that the generated warehouse operations forecast 104 becomes a simulated outcome (e.g., a forecast provided on a “what if” basis).

This concept of a simulated warehouse operations forecast 104 is particularly interesting when the data sets utilized to generate the forecast include one or more simulated MRP data sets. Simulated MRP data is already utilized in the industry to provide insight into the impact of different “what if” scenarios. Because this data already exists, it can be helpful to be able to use that data to support generation of multiple corresponding “what if” warehouse operations forecasts 104. This enables business managers working with variations of MRP data to coordinate effectively with warehouse managers working with corresponding warehouse operations forecasts 104.

In one embodiment, some or all of the current state data set 108 provided is indicative of relatively static business parameters. For example, data 108 illustratively includes a record of physical attributes of different types of product inventory (e.g., size, weight, shape, stackability, etc.). Another illustrative type of included data is a set of policies defining, for example, places where goods of a certain type are to be stored, etc. In one embodiment, some or all of the available resources data 110 provided is indicative of the current availability and status of product inventory. Another illustrative type of included data here is a set of policies related to warehouse organization, such as physical dimensions, internal organization into aisles, locations and their capacity, etc. In one embodiment, some or all of the known activities data 106 provided is indicative of details related to known and likely purchases, sales orders, and similar transactions and events likely to affect product inventory availability. In one embodiment, some or all of the supply schedule data 112 provided is indicative of details related to when, where and how product inventory is, will be, or has been available for warehouse processing. In one embodiment, some or all of the demand forecast data 114 provided includes a projection of how much product inventory is likely to be needed in the future and when it will be needed. These are examples only. Similar or other types of data can be included in data sets 106-110, and can be factored into the warehouse operations forecast 104 without departing from the scope of the present invention.

As will become more apparent, not all components of a warehouse operations forecast 104 need be primarily focused upon managing product inventory. A forecast 104 will also include components, for example, that are primarily focused upon managing human warehouse resources. Accordingly, the data sets 106-114 provided to support the generation of a forecast 104 are illustratively not limited to product inventory data. In one embodiment, some or all of the current state data 108 provided is indicative of relatively static business parameters related to human resources. For example, data 108 illustratively includes a record of employee work capacity profiles (e.g., number of hours that can be worked per pay period, ability or inability to lift large items, training status, capacity to fill different roles, etc.). In one embodiment, data 108 includes other resource indicators that have an impact on workload capacity (e.g., forklift or other equipment availability, etc.). In one embodiment, some or all of the available resources data 110 provided is indicative of the current, past and forward looking availability of human resources, in particular warehouse employee resources. These are examples only. Similar or other types of human resource data can be included in data sets 106-110, and can be factored into the generation of warehouse operations forecasts 104 without departing from the scope of the present invention.

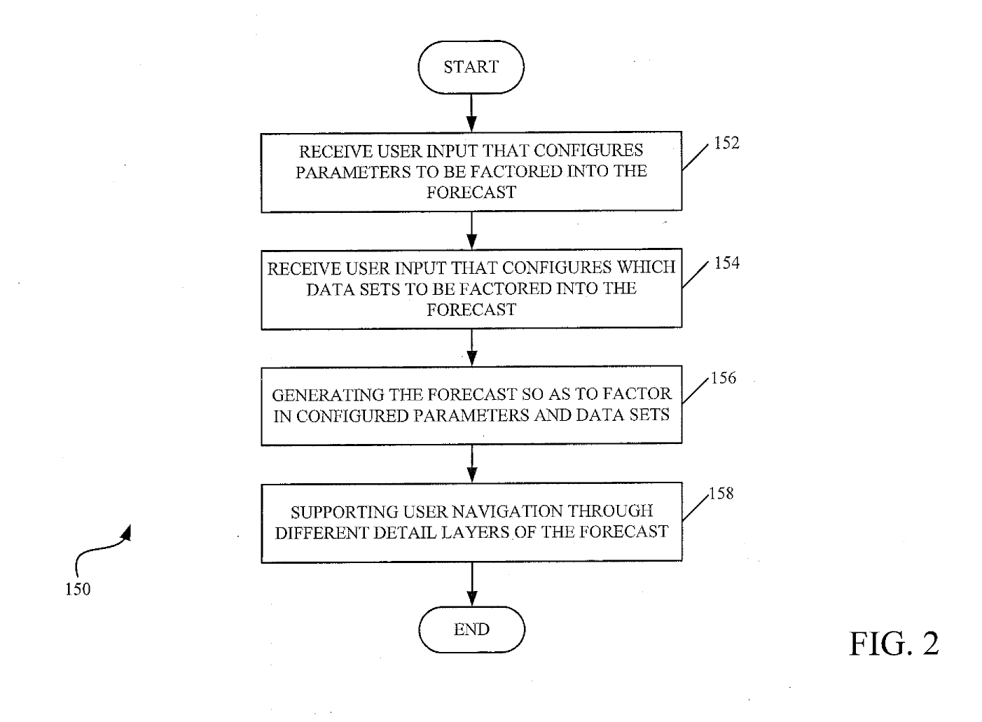

FIG. 2 shows a flow diagram illustrating one embodiment of a series of steps 150 utilized by data analysis component 102 to generate the warehouse operations forecast 104. In accordance with block 152, input is received from user 122. This input is illustratively received in relation to a user interface display 120 designed to facilitate collection of the input. The input indicates a particular set of user-selected parameters to be factored by component 102 into the forecast 104. Such parameters may include but are not limited to a desired time period(s) to be covered by the generated warehouse operations forecast 104.

In accordance with block 154, additional input is received from the user. Again, this input is illustratively received in relation to a user interface display 120 designed to facilitate collection of the input. This input illustratively includes an indication of which of a plurality of versions of a particular data set (e.g., a particular one of a plurality of different MRP simulations) is to be included in the forecast 104. Once all appropriate user inputs are received, in accordance with block 156, data analysis component 102 generates a corresponding warehouse operations forecast 104. Finally, in accordance with block 158, the system is configured to respond to user-initiated navigation commands so as to enable the user 122 to selectively drill up, down, and otherwise through different details and levels of detail of the forecast 104, which are illustratively presented at least in part as user interface displays 120. As will be described in greater detail below in relation to other Figures, the system thus enables the user to selectively review different levels of detail related to a future forecast of utilization of warehouse resources, such as but not limited to human and space resources.

It is worth mentioning that the scope of the present invention is not limited to, as block 158 might suggest, utilizing the generated forecast data to support user displays and user-driven functions and data navigation. The operations forecast data is illustratively exposed in accordance with a defined structure such that it is easily integrated into other system functions. For example, in one embodiment, the data is illustratively utilized by an automated warehouse management system so as to send notifications and/or to take other action when certain conditions or problems are identified.

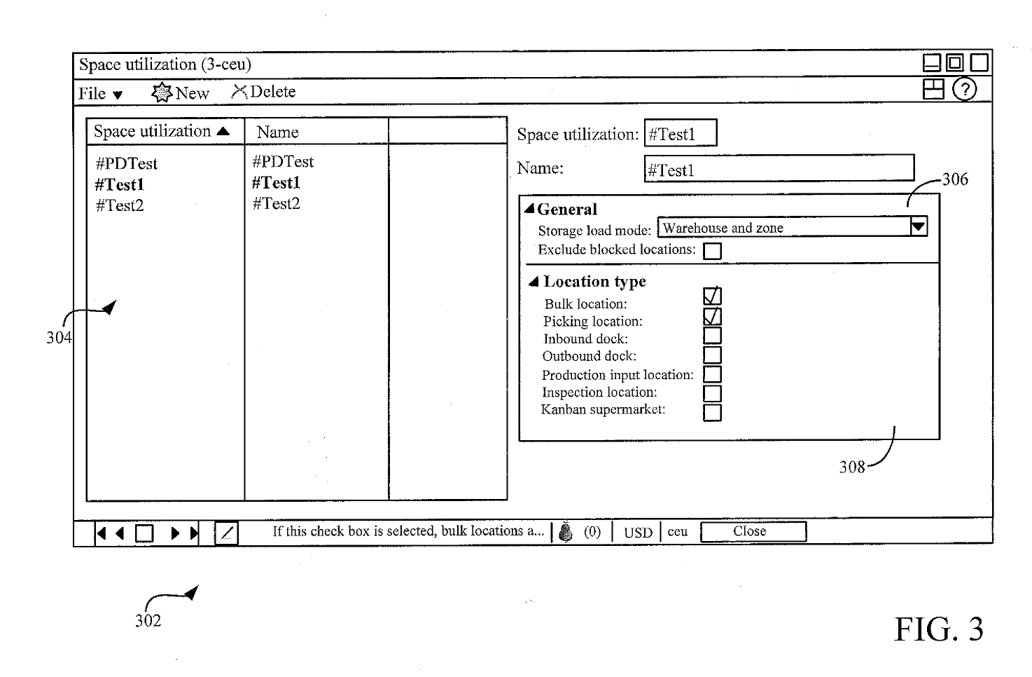

FIGS. 3-14 show a plurality of exemplary user interface displays that are generated during a process that is the same as (or similar to) that described in relation to FIG. 2, in the context of a system the same as (or similar to) that described in relation to FIG. 1. The user interface display 302 of FIG. 3 illustratively facilitates input/output interaction with user 122 during a configuration processes consistent with blocks 152 and 154 in FIG. 2. More particularly, display 302 facilitates a user-driven configuration of a warehouse space utilization component of a warehouse operations forecast 104 generated by the data analysis component 102 (e.g., generated in accordance with blocks 156 and 158 in the process of FIG. 2).

User interface display 302 includes an area 304 for selecting a particular one of a plurality of high level warehouse constructs (i.e., #PDTest, #Test1, #Test2, etc.) to which configuration options selected in areas 306 and 308 are to be applied. Each construct illustratively, but not necessarily and not by limitation, includes either one warehouse, a set of warehouses, or even a portion of a warehouse. The composition of warehouse units in each construct is illustratively a matter of system setup and user preference. The user is given the opportunity within the system to establish and adjust the allocation of warehouse units across the high level warehouse constructs in accordance with what makes the most sense in relation to actual business reality.

It is to be understood that the scope of the present invention is not strictly limited to the implementation details described herein. In another embodiment, area 304 enables the user to set specify a set of parameters—for example, there can be multiple warehouse managers working in a company, each of them interested in a different scope of information. One of them illustratively uses parameter set “#Test1”, the other “#Test2”, etc. The warehouse constructs used illustratively may (but do not necessarily have to) correspond to the warehouse structure set up in the ERP system.

Accordingly, once a warehouse construct is selected by the user within area 304, adjustments to the system parameters in areas 306 and 308 will be applied to the selected construct. In other words, areas 306 and 308 provide the user with the opportunity to set system options on a construct-specific basis. Once set, the options assigned to a given warehouse construct will be factored into the portions of the warehouse operations forecast 104 relevant to the construct. In this manner, the user is able to influence business and other presumptions applied to the generation of the forecast 104 by the data analysis component 102. Of course, display 302 itself is exemplary only at least in that other configuration options may be included without departing from the scope of the present invention.

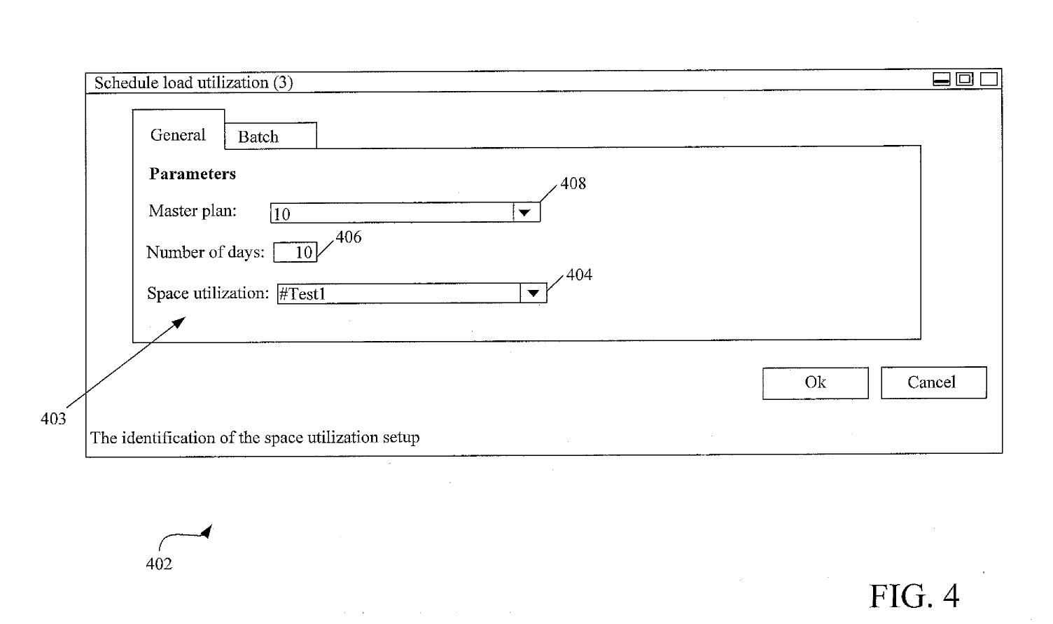

The user interface display 402 of FIG. 4 illustratively also facilitates input/output interaction with user 122 during the configuration processes reflected in blocks 152 and 154 of the FIG. 2 process. Further, display 402 also facilitates a user-driven configuration of a warehouse space utilization component of a generated forecast 104. However, unlike display 302, display 402 supports user-driven scheduling of calculations made in the process of populating a space utilization component with data. On a high level, however, displays 302 and 402 are both mechanisms that a user can use to set parameters and options in relation to the various warehouse constructs in order to influence the nature of the data and content of a generated forecast 104.

The user interface display 402 includes a control box 404 that enables a user to select a particular warehouse construct (i.e., #PDTest, #Test1, #Test2, etc.) to which configuration options selected in the other controls of an area 403 will be applied. For example, a control box 406 enables the user to set, for a given warehouse construct, a number of days to be included in forward looking (i.e., forward looking into the future in terms of time) space utilization projection included in a warehouse space utilization component of the forecasts 104.

The user interface display 402 also includes a control box 408 that enables the user to select one of a plurality of different data set alternatives to be factored by the data analysis component 102 into the derivation of the warehouse space utilization component of the forecast 104. In one embodiment, control box 408 is where the user selects a particular set of MRP simulation data to be the utilized set of MRP data in the context of the corresponding warehouse construct selected in box 404. Accordingly when the warehouse operations forecast 104 is generated by data analysis component 102, the selected warehouse space utilization component of the forecast will illustratively be configured so as to be consistent with the selected options as reflected in area 403. Of course, display 402 itself is exemplary only at least in that other configuration options may be included without departing from the scope of the present invention.

Accordingly, displays 302 and 402 enable a user to set warehouse constructs (e.g., choose desired warehouses and selectively group them, etc.), to choose transaction types taken into account, choose resource limits to display, choose or change the considered MRP plan or other multi-version data source, choose a forecast length, etc. In this manner, the user can influence how data analysis component 102 goes about generating the warehouse space utilization component of a warehouse operations forecast 104.

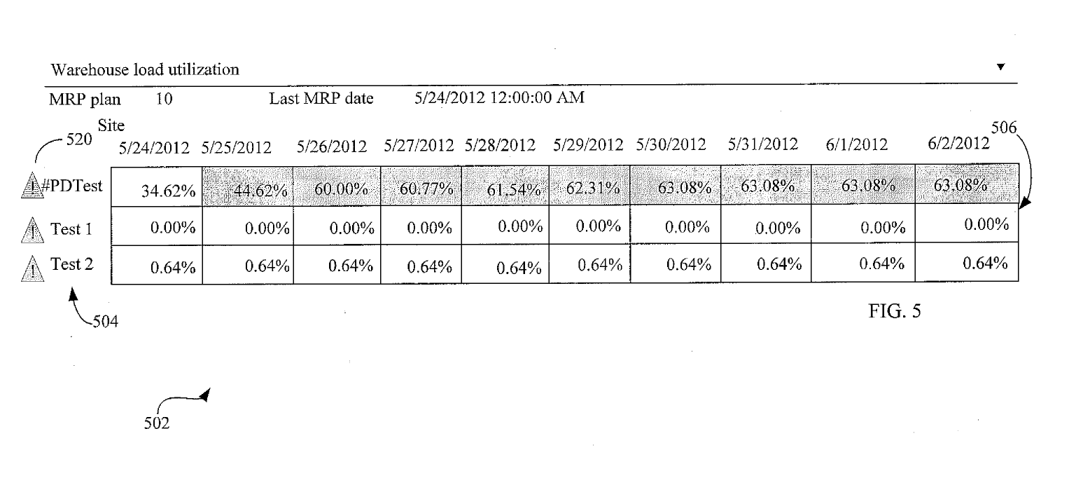

In one embodiment, the warehouse space utilization component of a forecast 104 is implemented as a series of user navigable hierarchical displays organized from more general to more detailed in terms of the information presented. The user interface display 502 of FIG. 5 is an illustrative example of a most general level of the hierarchy of the warehouse space utilization component. Display 502 enables a warehouse manager to easily spot when a problem exists in terms of how much warehouse space is or is not likely to be available in the future. Column 504 includes an identifier for each of three rows. Each of these identifiers represents a warehouse construct, a concept that was discussed above in relation to area 304 of FIG. 3 (e.g., each construct can be a different warehouse combination, or a different set of parameters, etc.). Consistent with the ten day forecast setting alluded to in relation to FIG. 4, each warehouse construct row has ten associated cells, one for each day. Each cell includes a percentage indicating the likely level of warehouse space usage on that day in the future.

In one embodiment, the system is configured to compare one or more of the percentage values included within the cells to a threshold value (e.g., a user selected threshold value entered as a system setting, a factory selected threshold value, an automatically determined value, etc.). In one embodiment, the system is configured to support comparisons not only to values within a cell, but also values corresponding to sub-constructs belonging to a considered construct, etc. Depending upon the result of this comparison, one or more cells may be visually emphasized in order to provide a clear indication to the user that there may be a problem with the amount of warehouse space used or not used on that particular day. Within FIG. 5, most of the cells in row 506 have been shaded in order to tip off the user that there may be a problem worth looking into. In one embodiment, the user is able to get more information about the possible problem by entering a system command and causing the display to transition to a more detailed level of the hierarchy of the warehouse space utilization component of the forecast 104.

Display 502 shows data for three warehouse constructs (i.e., constructs #PDTest, Test1 and Test2). However, the user may be interested in having more detail about just one construct, such as the construct #PDTest that indicates by its shading in FIG. 5 that there is a potential warehouse space problem. In one embodiment, the system is configured to respond to a navigation input from the user by transitioning to a more detailed level of the warehouse space utilization component of the forecast 104.

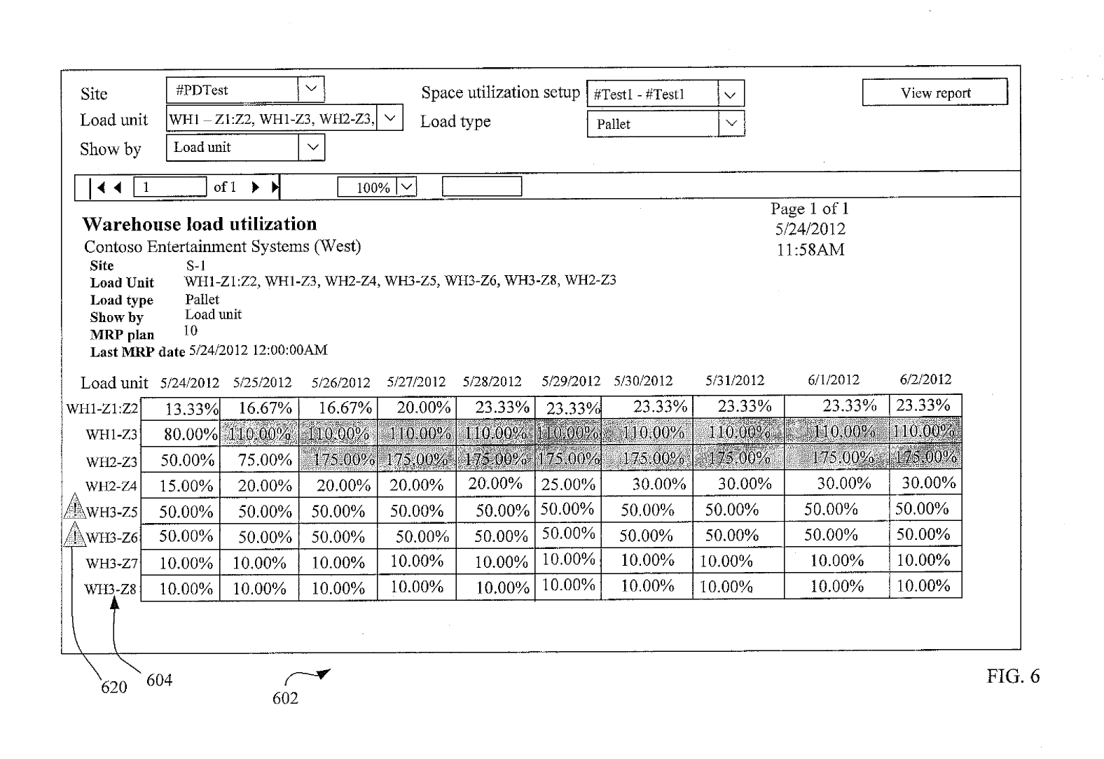

FIG. 6 is an illustrative example of a next more detailed level of the hierarchy of the warehouse space utilization component of the forecast 104. User interface display 602 enables the warehouse manager to easily gain more insight into the particular construct where the future warehouse space problem represented by the shading exists. Column 604 includes an identifier for each of eight rows. Each of these identifiers represents a warehouse included in the selected construct #PDTest. Thus, the user is now able to see a breakdown of the individual components of the selected warehouse construct. Consistent with the ten day forecast setting described in relation to the display of FIG. 4, each warehouse row has ten associated cells, one for each day. Each cell includes a percentage indicating the likely level of warehouse space usage on that day.

In one embodiment, in the context of display 602, the system is again configured to compare one or more of the percentage values included within the cells to a threshold value (e.g., a user selected threshold value entered as a system setting, a factory selected threshold value, an automatically determined value, etc.). Depending upon the result of this comparison, one or more cells may be visually emphasized in order to provide a clear indication that there may be a problem with the amount of warehouse space used or not used on that particular day. Within FIG. 6, portions of several rows are shaded where the projected warehouse space exceeds 100 percent. While the more than 100 percent problem did not show up in the percentages in the table of display 502, the shading did indicate an underlying issue. Drilling down to the next level reveals to the user that the current plan leads to an unworkable forecast wherein more warehouse spaced is needed than is available.

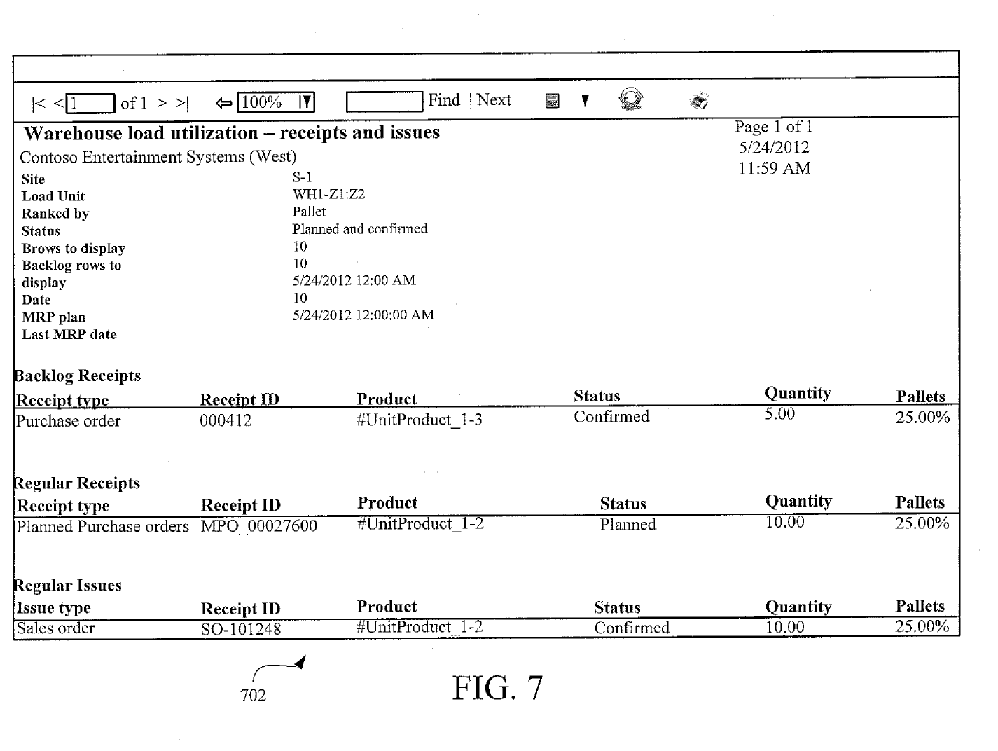

FIG. 7 is an illustrative example of a still more detailed level of the hierarchy of the warehouse space utilization component of the forecast 104. User interface display 702 enables the warehouse manager to gain even more insight into a particular warehouse or other construct or unit included in a previous level of the hierarchy. In this case, display 702 shows specific transactions occurring on specific days for a particular one of the selected problem warehouses. This is useful, for example, when the warehouse manager desires to see exactly what transaction or transactions may have produced the area in the forecast where the future warehouse space problem was represented by shading.

In one embodiment, the system is configured to monitor characteristics of the status of the system for circumstances where there may be an issue with the integrity of data that is being provided as part of a forecast 104. When such circumstances are detected, corresponding warning notations are added to one or more of the user interface displays in order to let the user know that certain particular data sets may be incomplete or inconsistent. Examples of this are shown in FIGS. 5 and 6 where warning symbols have been included next to certain data elements (an illustrative two of the symbols are labeled as items 520 and 620). In accordance with one embodiment, these symbols are indicative of the fact that the associated portion of the component of the forecast 104 could be flawed because there is an inconsistency in the information used to generate the component and/or some configuration fields have been left blank rather than being supplied with a value to include in the calculation. Such an indication need not necessarily be made with a symbol such as symbols 520 and 620. A coloring, shading or any other indicator can be alternatively utilized without departing from the scope of the present invention.

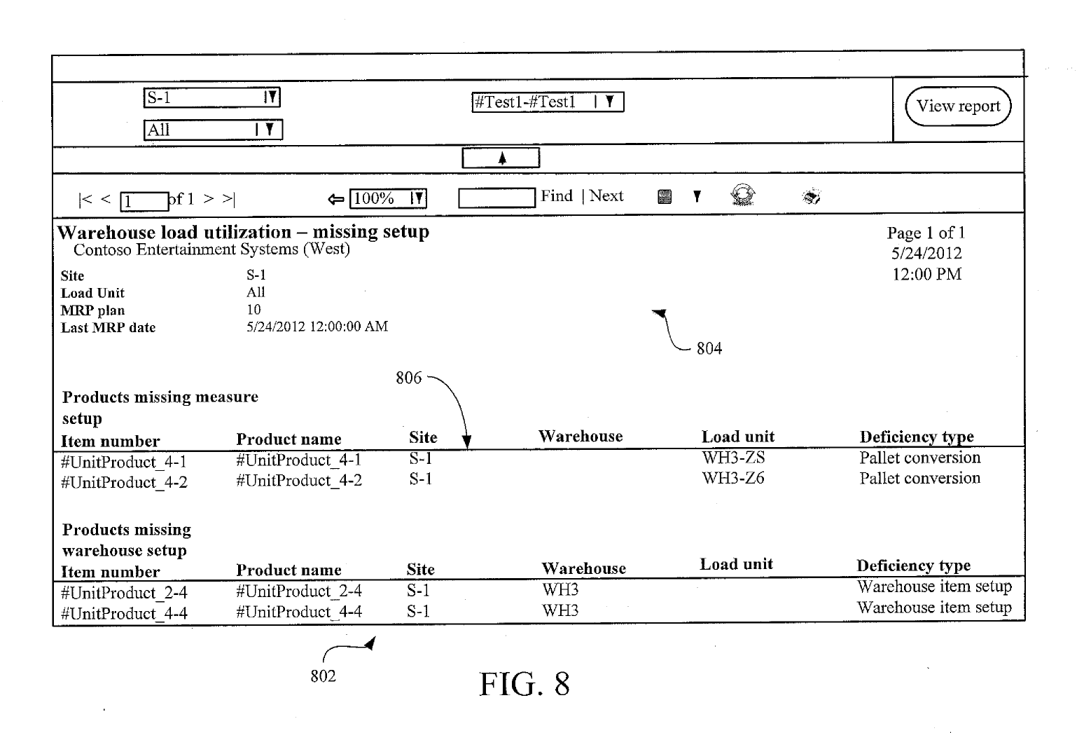

FIG. 8 is an illustrative example of a display that is illustratively, though not likely exclusively, accessed by navigating a link associated with a warning symbol such as symbols 520 and 620. Area 804 provides information as to the context for the missing setup or data concerns. Area 806 provides a listing of inconsistencies, missing data, etc. that when resolved will eliminate the motivation for the warning symbols. In embodiment, the system is configured to enable the user to quickly navigate to interface elements where issues related to missing or inconsistent data are easily resolvable by way of acquisitions of additional user input, etc.

Up to this point, the discussed user interface displays associated with the warehouse operations forecast 104 have been focused primarily on warehouse space management. The scope of the present invention is not so limited. In another embodiment, the forecast 104 also includes forecast components showing a projected utilization of warehouse resources other than warehouse space.

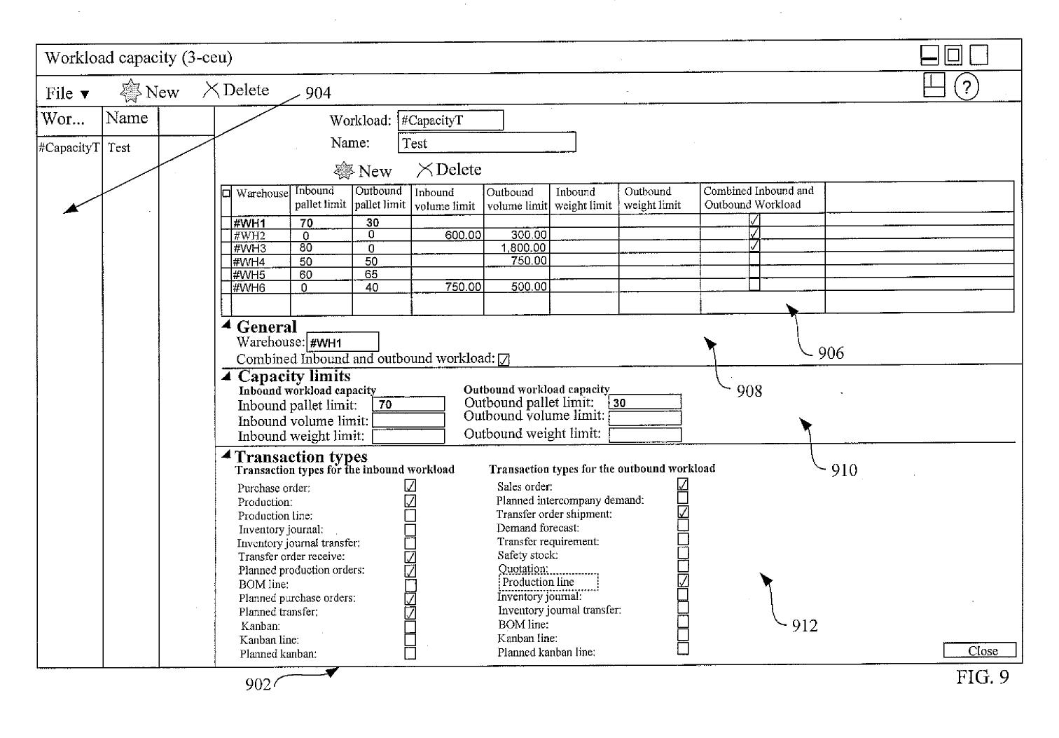

FIG. 9 is a screen shot representation of another user interface display 902 that facilitates input/output interaction with user 122, for example, in association with the configuration processes the same or similar to those described above in relation to process blocks 152 and 154 in FIG. 2. In particular, display 902 facilitates a user-driven configuration of a warehouse workload utilization component of the warehouse operations forecast 104 generated by the data analysis component 102 (e.g., generation in accordance with blocks 156 and 158 in the process of FIG. 2). As will become apparent, the warehouse workload utilization component provides information pertaining to projected use of and demand for human warehouse resources.

User interface display 902 includes an area 904 for selecting a particular one of the plurality of warehouse constructs (e.g., the same constructs #PDTest, #Test1, #Test2, etc. described in the context of the space utilization interfaces) to which configuration options selected in areas 906, 908, 910 and 912 are to be applied. Each construct illustratively, but not necessarily and not by limitation, includes one warehouse, a set of warehouses, or even a portion of a warehouse. In the example shown in FIG. 9, the selected construct includes six different warehouses (i.e., #WH1, #WH2, #WH3, etc.), which are represented in the six lines of data shown in area 906. The table in area 906 shows the status of different workload parameter controls relative to the different warehouses. Warehouse constructs can illustratively be added, deleted, or altered at least bay way of automated programmatic means or by way of user input.

As has been discussed previously, the constructs (e.g., the same constructs #PDTest, #Test1, #Test2, etc. described in the context of the space utilization interfaces) may alternatively each represent a different set of parameters (e.g., corresponding to different warehouse managers, seasonal changes, etc.). In this case, component 906 is illustratively the list of warehouses considered in the context of the selected set of parameters. Both alternatives, and other similar variations, are to be considered within the scope of the present invention.

Using the controls in area 906, 908, 910 and/or 912, the user is able to enter warehouse-specific information related to the capacity for work to get done (e.g., depending upon human labor capacity considerations, automated labor capacity considerations, etc.). For example, the user has indicated in FIG. 9 that the workload resources available in the first warehouse (i.e., #WH1) are such that only 70 in-bound pallets and 30 out-bound pallets can be handled within a particular time period (e.g., within a day of warehouse operation, within a shift, within a user-selected forecast period, etc.). These limitations are illustratively utilized programmatically by data analysis component 102 to support a calculation of the data presented within the warehouse workload component of the warehouse operations forecast 104. Of course, display 902 itself is exemplary only at least in that other configuration options may be included without departing from the scope of the present invention.

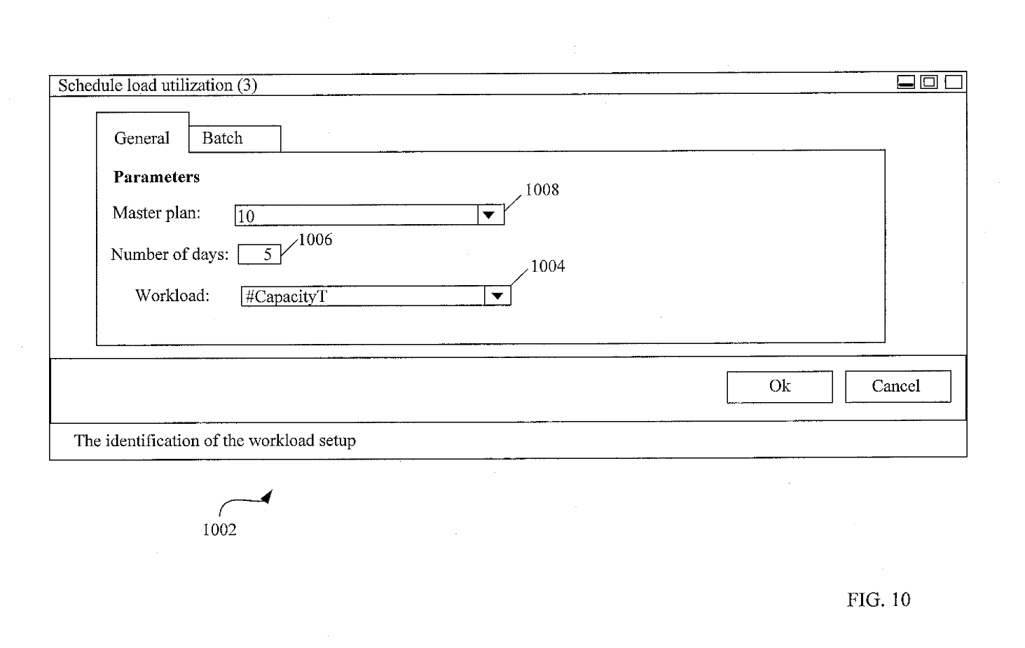

The user interface display 1002 of FIG. 10 illustratively also facilitates input/output interaction with user 122 during the configuration processes described in relation to process blocks 152 and 154 in FIG. 2. Display 1002 facilitates a user-driven configuration of the warehouse workload utilization component of a forecast 104. In particular, a control box 1004 supports selection of a warehouse constructs (i.e., #PDTest, #Test1, #Test2, etc.) to which configuration options selected in areas 1006 and 1008 are to be applied. A control box 1006 supports the setting of a number of days to be included in the forward looking (i.e., forward looking into the future in terms of time) workload utilization component of the forecast 104. A control box 1008 enables a user to select one of a plurality of different data set alternatives to be factored by the data analysis component 102 into the forecast. In one embodiment, control box 1008 is where the user selects a particular set of MRP data to be the utilized set of MRP data. Of course, display 602 is itself exemplary only at least in that other configuration options may be included without departing from the scope of the present invention.

Accordingly, interface displays 902 and 1002 enable a user to set warehouse constructs (e.g., choose desired warehouses and selectively group them, etc.), choose transaction types taken into account, choose resource limits to display, choose or change the considered MRP plan or other multi-version data source, choose a forecast length, etc. In this manner, the user can influence how data analysis component 102 goes about generating the warehouse workload utilization component of a warehouse operations forecast 104.

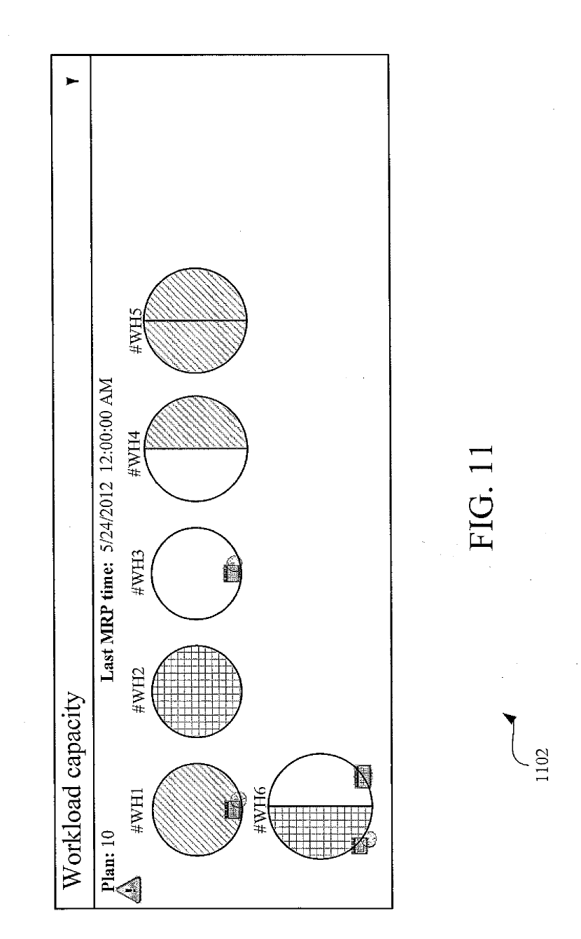

In one embodiment, the warehouse workload utilization component is also implemented as a series of user navigable hierarchical displays organized from more general to more detailed in terms of the information presented. The user interface display 1102 of FIG. 11 is an illustrative example of a general level of the hierarchy of the warehouse workload utilization component. Display 1102 enables a warehouse manager to easily spot when a problem exists in terms of the warehouse workload resources that are or are not likely to be available in the future. Each circle shape in display 1102 represents a different warehouse. Those skilled in the art will appreciate that an even more general level of the hierarchy could be provided wherein each circle represents a different one of the warehouse constructs instead of the warehouses within a construct. In that case, each of the broader warehouse construct representations would be navigable to the underlying representation of a related warehouse or warehouses. For the purposes of the present description, however, it will simply be assumed that a display that operates in a manner substantially similar to that which will be described in relation to FIG. 11 could just as easily be provided so as to focus upon the higher warehouse construct level in the hierarchy.

Turning back to the warehouse representation of FIG. 11, each of the circle shapes represents a different warehouse (i.e., #WH1, #WH2, etc.) in the selected warehouse construct. The shading of the circle shapes indicates whether or not there are enough, too many, or not the forecast 104 projects enough warehouse workload resources being available during a selected, forward looking projection time period. The system is configured to enable the user to navigate from the warehouse to a different but related display showing more detailed information for any one of the represented warehouses. For example, if the shading indicates that there is a projected workload problem with one of the warehouses, the user can select that warehouse in order to drill down for more detail pertaining to the nature of the problem.

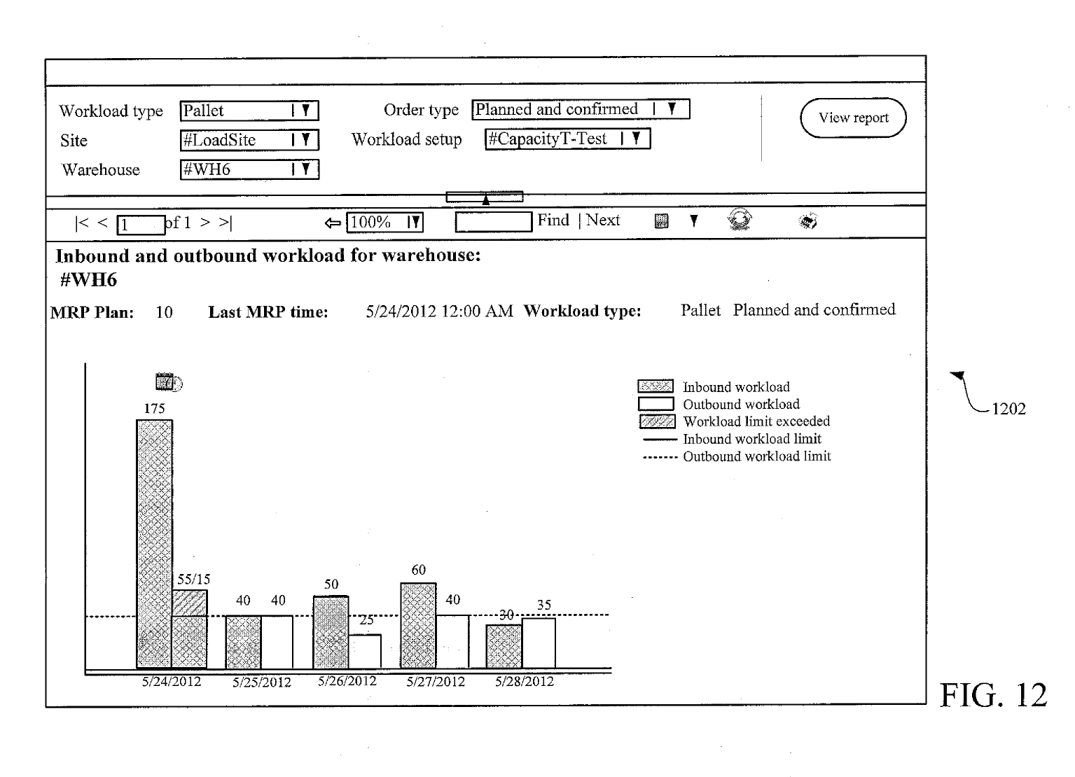

The user interface display 1202 of FIG. 12 is an illustrative example of a user interface providing a detailed representation of workload for a single warehouse over an upcoming N days (e.g., number of days in forecast is an adjustable variable, as has been described). Display 1202 is illustratively navigated to following selection of a particular warehouse from within display 1102. Of course, those skilled in the art will appreciate that a user is able to drill up and down through the different available levels of detail and construct/warehouse perspectives on a selective basis.

Display 1202 includes a bar chart with a set of workload bars for each of N days over a selected forecast period. The shading of the bars is indicative of whether the generated forecast 104 indicates enough inbound and outbound workload capacity. In one embodiment, the system selects the shading for the workload status (or selects coloring, or symbols, etc.) based on a system initiated comparison to a threshold value (e.g., a user selected threshold value entered as a system setting, a factory selected threshold value, an automatically generated value, etc.). Depending upon the result of this comparison, none, one or more bars in the bar chart of display 1202 are visually emphasized in order to provide a clear indication that there may be (or may not be) a problem with the amount of warehouse space used or not used on each particular day. In one embodiment, the user is able to get more information about any of the represented forecast days by entering a system command and causing the display to transition to a more detailed level of the hierarchy of the warehouse workload utilization component. In another embodiment, bars are partially emphasized; for example, a part of the bar corresponds to a problem being emphasized and the part that does not correspond to the problem not being emphasized.

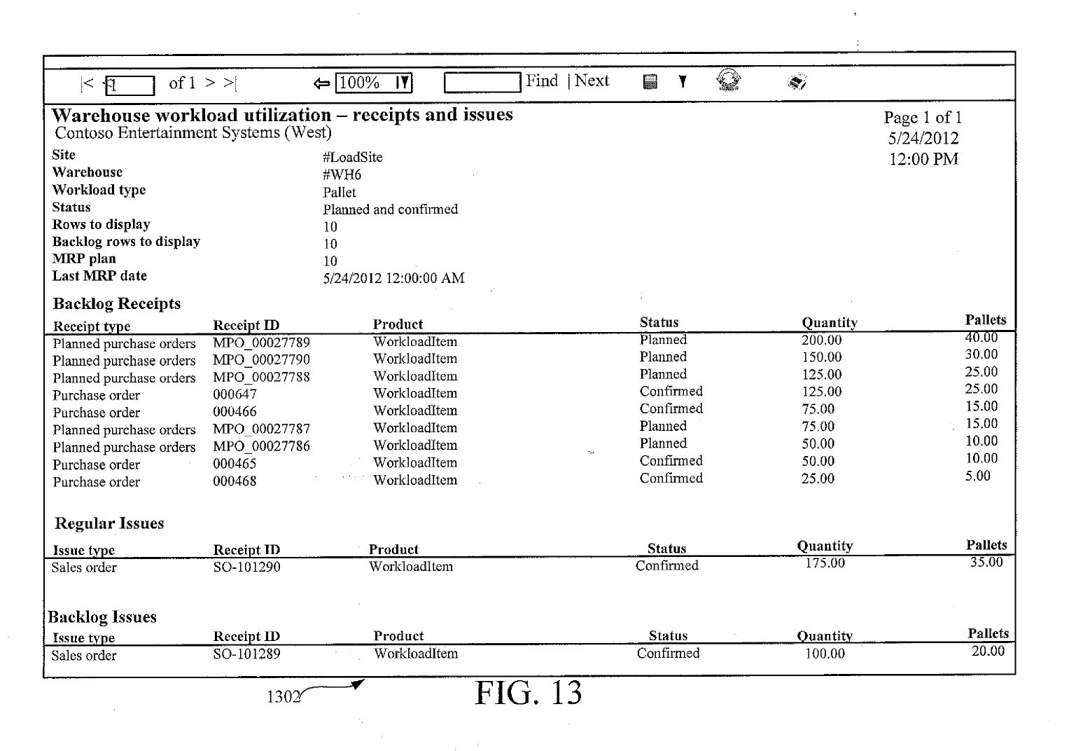

FIG. 13 is an illustrative example of a next more detailed level of the hierarchy of the warehouse workload utilization component of a forecast 104. User interface display 1302 shows transactions happening on a specific day for a specific warehouse. Thus, display 1302 enables the warehouse manager to easily gain more insight into future warehouse workload issues, such as the issues represented by the shading, coloring, and/or other issue notification mechanisms present in the higher levels of the display hierarchy. This is useful, for example, when the warehouse manager desires to see exactly what transaction or transactions may have produced an area in the forecast where a future warehouse workload problem exists.

Again, the system is illustratively configured to automatically monitor for circumstances where there may be an issue with the integrity of the data. When such circumstances are detected in relation to the warehouse workload utilization component of a forecast 104, corresponding warning notations are added to the user interface displays in order to let the user know how certain particular data sets may be incomplete or inconsistent. Examples of this are shown in FIGS. 11 and 12 where small warning icons or symbols have been included next to certain data visualization elements. In accordance with one embodiment, these symbols are indicative of the fact that the associated portion of the component of the forecast 104 component could be flawed because there is an inconsistency in the information used to generate the component and/or some fields were left blank rather than being supplied with a value to include in the calculation. Such an indication need not necessarily be made with a symbol or icon. A coloring, shading or any other indicator can be alternatively utilized without departing from the scope of the present invention.

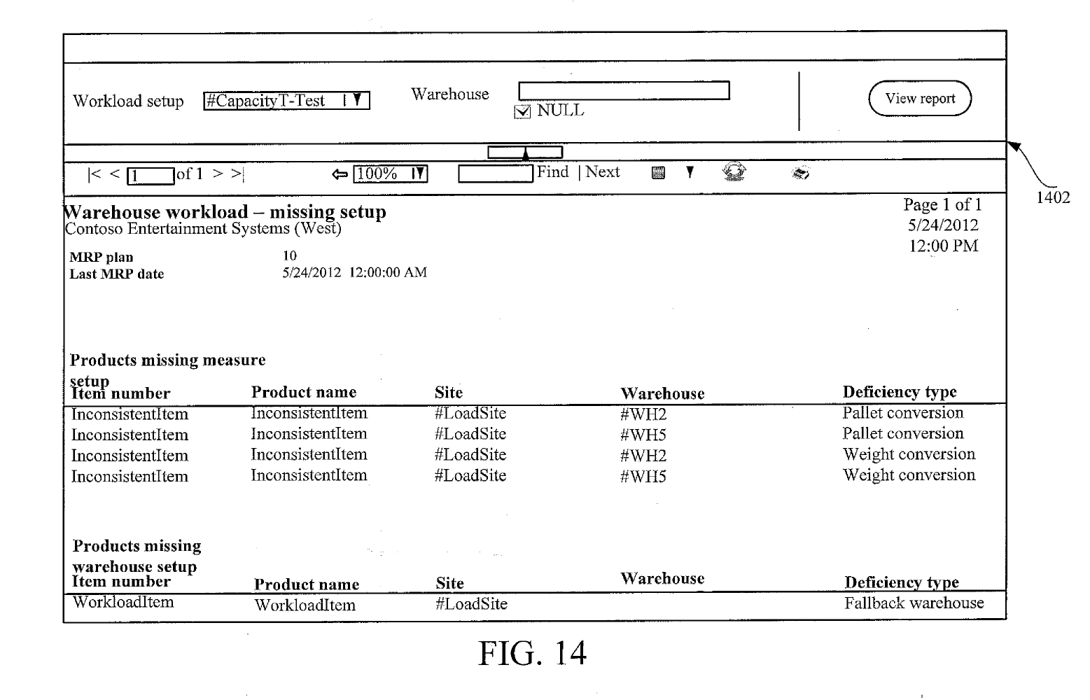

FIG. 14 is an example of a display that is illustratively accessed by navigating a link associated with a warning symbol or icon. The heading information at the top of display 1402 provides information as to the context for missing setup or inconsistent data concerns. The area at the bottom of display 1402 provides a listing of inconsistencies, missing data, and the like that when resolved will eliminate the motivation for the warning indicators. In one embodiment, the system is configured to enable the user to quickly navigate to interface display elements where issues related to missing or inaccurate data are easily resolvable by way of submissions of additional user input.

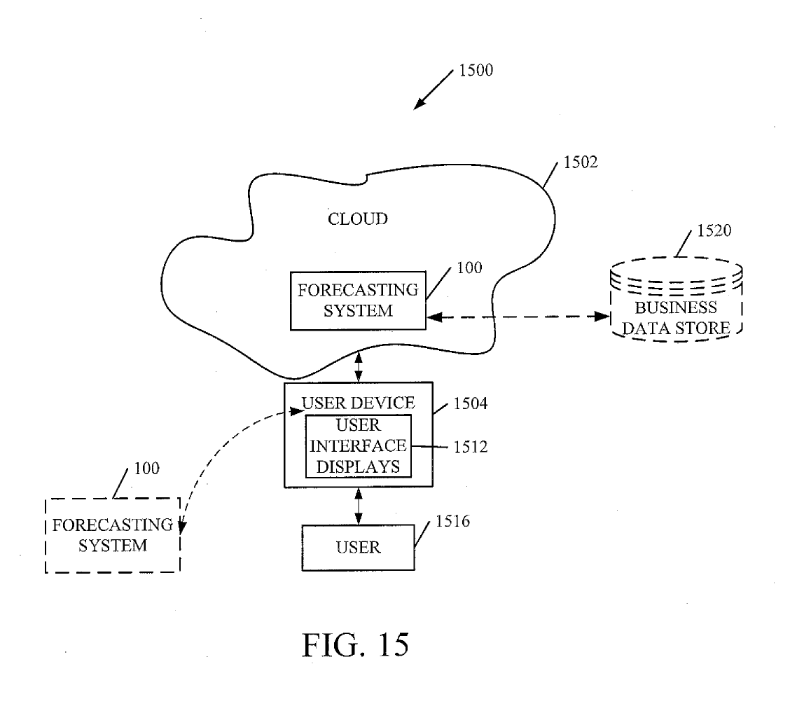

FIG. 15 is a block diagram showing forecasting system 100 (FIG. 1) in the context of an exemplary cloud computing architecture 1500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of forecasting system 100, as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description herein is intended to include both public cloud computing and private cloud computing. Cloud computing (both public and private) provides substantially seamless pooling of resources, as well as a reduced need to manage and configure underlying hardware infrastructure. A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The cloud architecture embodiment shown in FIG. 15 shows forecasting system 100 located in cloud 1502 (which can be public, private, or a combination where portions are public while others are private). Therefore, user 1516 uses a user device 1504 to access the forecasting system components, including user interface displays 1512, through the cloud 1502.

FIG. 15 also depicts another embodiment of cloud architecture. FIG. 15 shows that it is also contemplated that some elements of forecasting system 100 are disposed in cloud 1502 while others are not. By way of example, data store 1520 can be disposed outside of cloud 1502, and accessed through cloud 1502. In another embodiment, some or all of the other components of forecasting system 100 are also outside of cloud 1502. Regardless of where they are located, they can be accessed by device 1504, through a network (either a wide area network or a local area network), they can be hosted at a remote site by a service, or they can be provided as a service through a cloud or accessed by a connection service that resides in the cloud. All of these architectures are contemplated herein.

It is also worth noting that, although it is not specifically shown in FIG. 15, some or all of the portions of forecasting system 100 can be located on device 1504. All or a portion of forecasting system 100 can be disposed on a wide variety of different devices. Some of those devices include servers, desktop computers, laptop computers, tablet computers, or other mobile devices, such as palm top computers, cell phones, smart phones, multimedia players, personal digital assistants, etc.

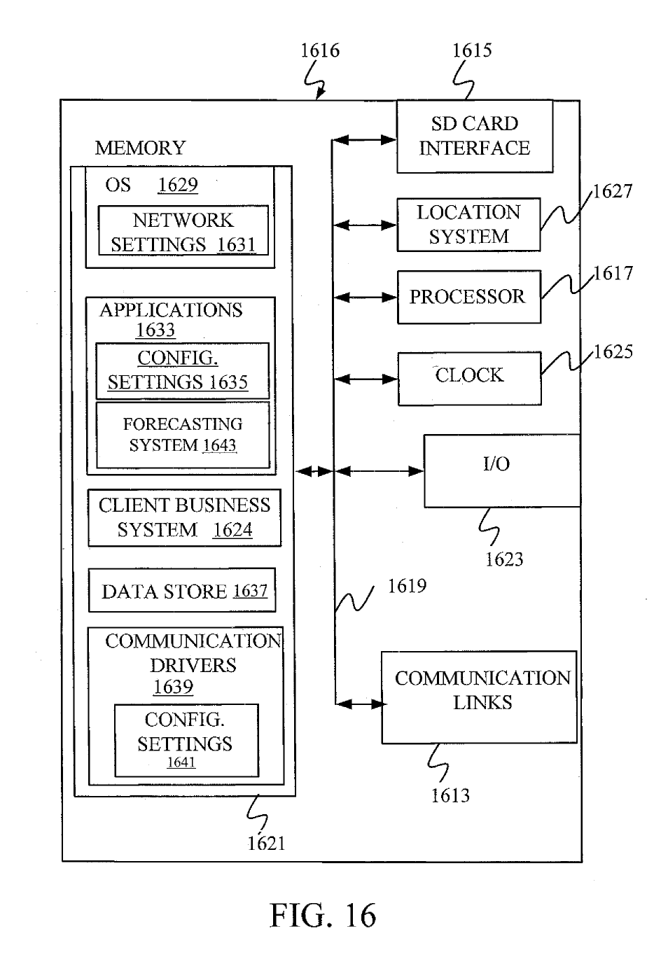

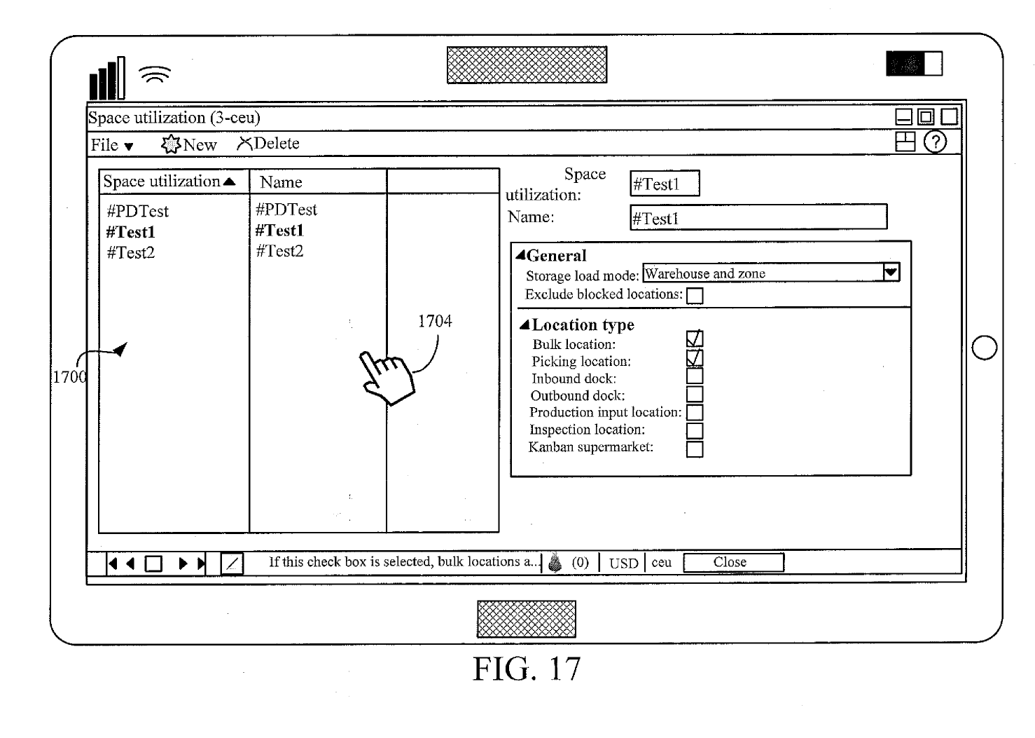

FIG. 16 is a simplified block diagram of one illustrative embodiment of a handheld or mobile computing device that can be used as a user's or client's hand held device 1616, in which embodiments of the forecasting system of the present invention (or at least parts of it) can be deployed. FIGS. 17-19 are then more specific examples of handheld or mobile devices.

FIG. 16 provides a general block diagram of the components of a client device 1616 that can run components of forecasting system 100 or that interacts with forecasting system 100, or both. In the device 1616, a communications link 1613 is provided that allows the handheld device to communicate with other computing devices and under some embodiments provides a channel for receiving information automatically, such as by scanning. Examples of communications link 1613 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like forecasting system 100) are received on a removable Secure Digital (SD) card that is connected to a SD card interface 1615. SD card interface 1615 and communication links 1613 communicate with a processor 1617 (which can also embody processor 118 from FIG. 1) along a bus 1619 that is also connected to memory 1621 and input/output (I/O) components 1623, as well as clock 1625 and location system 1627.

I/O components 1623, in one embodiment, are provided to facilitate input and output operations. I/O components 1623 for various embodiments of the device 1616 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 1623 can be used as well.

Clock 1625 illustratively comprises a real time clock component that outputs a time and date. It can also, illustratively, provide timing functions for processor 1617.

Location system 1627 illustratively includes a component that outputs a current geographical location of device 1616. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1621 stores operating system 1629, network settings 1631, applications 1633, application configuration settings 1635, data store 1637, communication drivers 1639, and communication configuration settings 1641. Memory 1621 can include all types of tangible volatile and non-volatile computer-readable memory devices. It can also include computer storage media (described below). Memory 1621 stores computer readable instructions that, when executed by processor 1617, cause the processor to perform computer-implemented steps or functions according to the instructions. Forecasting system 100 or the items in data store 124, for example, can reside in memory 1621. Similarly, device 1616 can have a client business system 1624 that can run various business applications or embody parts or all of forecasting system 100. Processor 1617 can be activated by other components to facilitate their functionality as well.

Examples of the network settings 1631 include things such as proxy information, Internet connection information, and mappings. Application configuration settings 1635 include settings that tailor the application for a specific enterprise or user. Communication configuration settings 1641 provide parameters for communicating with other computers and include items such as GPRS parameters, SMS parameters, connection user names and passwords.

Applications 1633 (including application 1643, which is illustratively an application component facilitating functionality of forecasting system 100) can be applications that have previously been stored on the device 1616 or applications that are installed during use, although these can be part of operating system 1629, or hosted external to device 1616, as well.

FIG. 17 shows an embodiment in which device 1616 is a tablet computer 1700. In FIG. 17, computer 1700 is shown with the user interface display of FIG. 3 on display screen 1702. Screen 1702 can be a touch screen (so touch gestures from a user's finger 1704 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 1700 can also illustratively receive voice inputs as well.

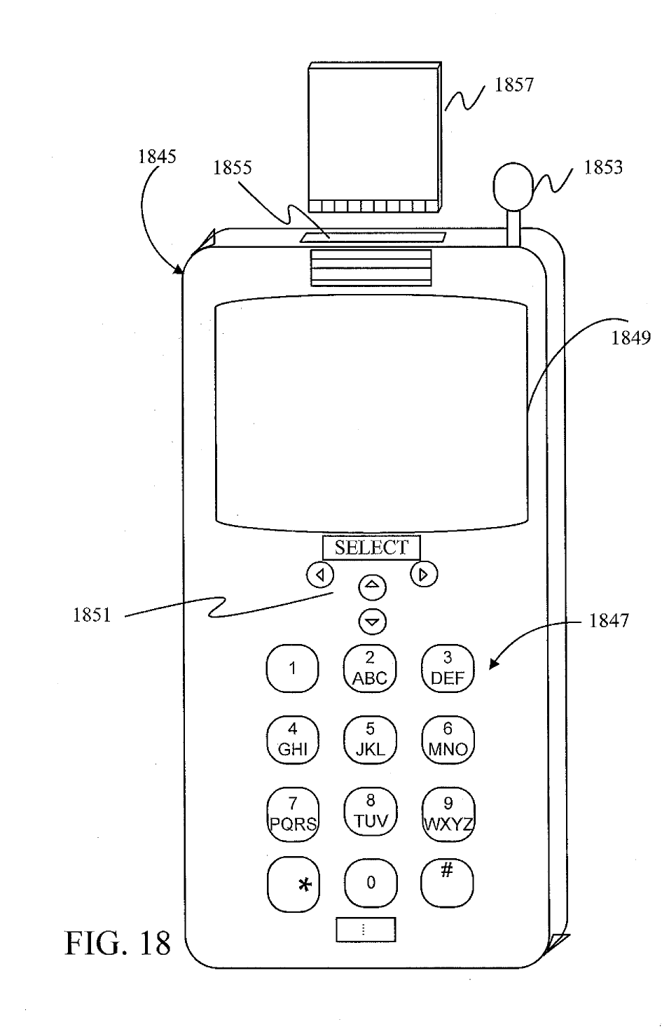

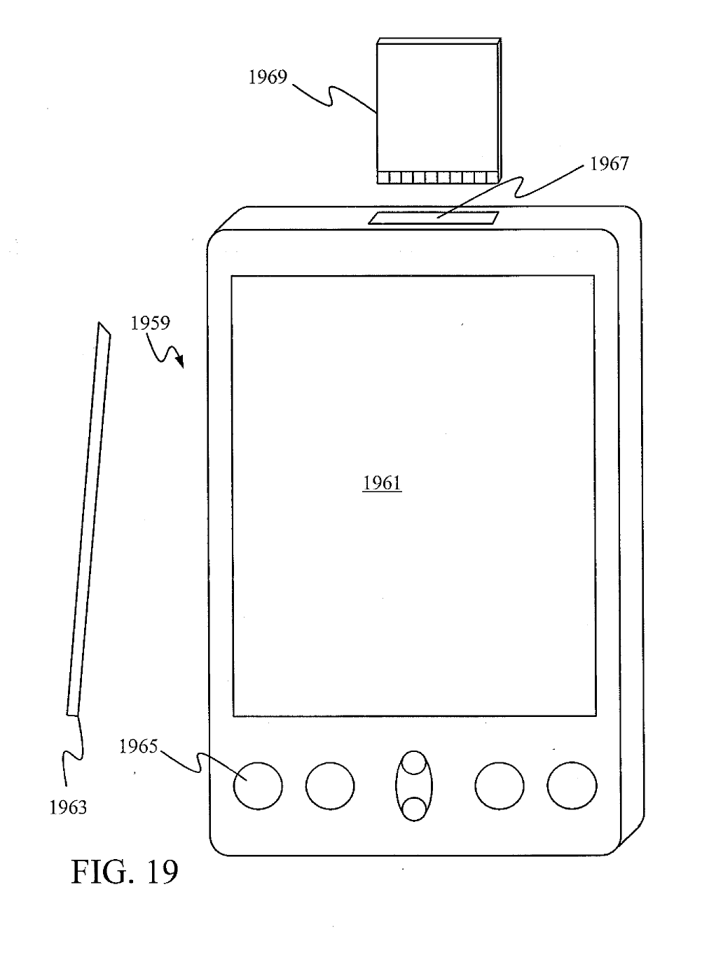

FIGS. 18 and 19 provide additional examples of devices 1616 that can be used, although others can be used as well. In FIG. 18, a smart phone or mobile phone 1845 is provided as the device 1616. Phone 1845 includes a set of keypads 1847 for dialing phone numbers, a display 1849 capable of displaying images including application images, icons, web pages, photographs, and video, and control buttons 1851 for selecting items shown on the display. The phone includes an antenna 1853 for receiving cellular phone signals such as General Packet Radio Service (GPRS) and 1×rtt, and Short Message Service (SMS) signals. In some embodiments, phone 1845 also includes a Secure Digital (SD) card slot 1855 that accepts a SD card 1857.

The mobile device of FIG. 19 is a personal digital assistant (PDA) 1859 or a multimedia player or a tablet computing device, etc. (hereinafter referred to as PDA 1859). PDA 1859 includes an inductive screen 1861 that senses the position of a stylus 1863 (or other pointers, such as a user's finger) when the stylus is positioned over the screen. This allows the user to select, highlight, and move items on the screen as well as draw and write. PDA 1859 also includes a number of user input keys or buttons (such as button 1865) which allow the user to scroll through menu options or other display options which are displayed on display 1861, and allow the user to change applications or select user input functions, without contacting display 1861. Although not shown, PDA 1859 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 1859 also includes a SD card slot 1867 that accepts a SD card 1869.

Note that other forms of the device 1616 are possible and should most certainly be considered within the scope of the present invention.

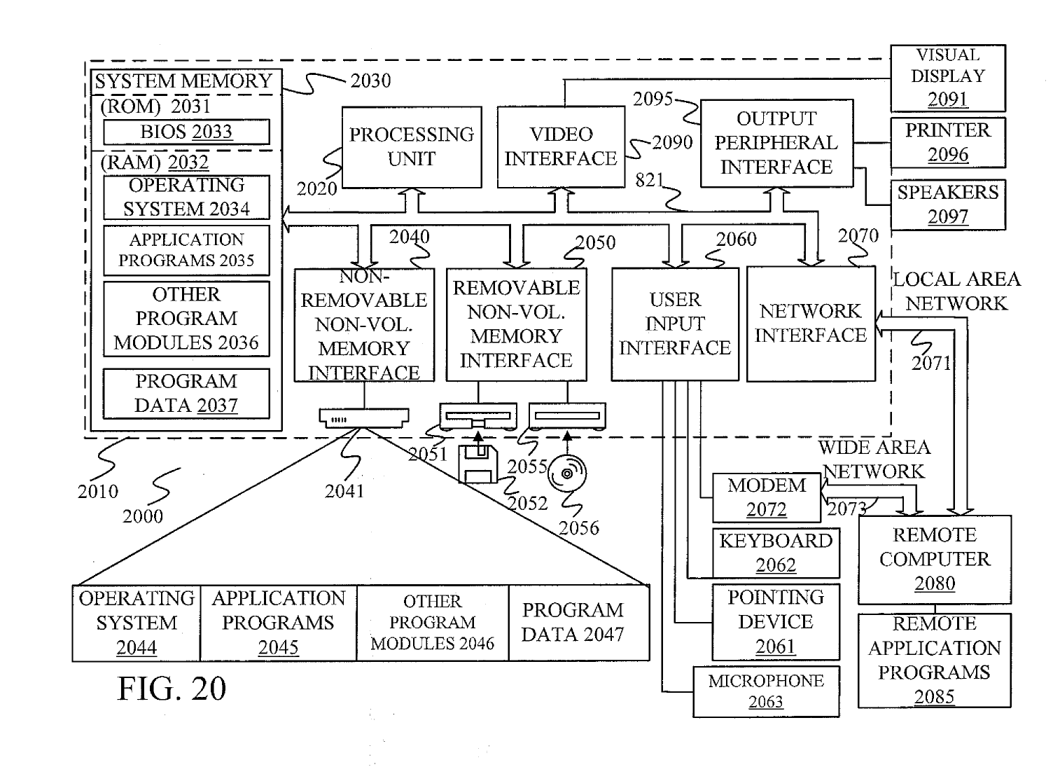

FIG. 20 is one embodiment of a computing environment in which forecasting system 100 (for example) can be deployed. With reference to FIG. 20, an exemplary system for implementing some embodiments includes a general-purpose computing device in the form of a computer 2010. Components of computer 2010 may include, but are not limited to, a processing unit 2020 (which can comprise processor 118), a system memory 2030, and a system bus 2021 that couples various system components including the system memory to the processing unit 2020. The system bus 2021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 14.

Computer 2010 typically includes a variety of computer readable media. Computer readable media can be any available media that can be accessed by computer 2010 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2010. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 2030 includes computer storage media in the form of volatile and/or nonvolatile memory such as read only memory (ROM) 2031 and random access memory (RAM) 2032. A basic input/output system 2033 (BIOS), containing the basic routines that help to transfer information between elements within computer 2010, such as during start-up, is typically stored in ROM 2031. RAM 2032 typically contains data and/or program modules that are immediately accessible to and/or presently being operated on by processing unit 2020. By way of example, and not limitation, FIG. 14 illustrates operating system 2034, application programs 2035, other program modules 2036, and program data 2037.

The computer 2010 may also include other removable/non-removable volatile/nonvolatile computer storage media. By way of example only, FIG. 14 illustrates a hard disk drive 2041 that reads from or writes to non-removable, nonvolatile magnetic media, a magnetic disk drive 2051 that reads from or writes to a removable, nonvolatile magnetic disk 2052, and an optical disk drive 2055 that reads from or writes to a removable, nonvolatile optical disk 2056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2041 is typically connected to the system bus 2021 through a non-removable memory interface such as interface 2040, and magnetic disk drive 2051 and optical disk drive 2055 are typically connected to the system bus 2021 by a removable memory interface, such as interface 2050.

The drives and their associated computer storage media discussed above and illustrated in FIG. 14, provide storage of computer readable instructions, data structures, program modules and other data for the computer 2010. In FIG. 14, for example, hard disk drive 2041 is illustrated as storing operating system 2044, application programs 2045, other program modules 2046, and program data 2047. Note that these components can either be the same as or different from operating system 2034, application programs 2035, other program modules 2036, and program data 2037. Operating system 2044, application programs 2045, other program modules 2046, and program data 2047 are given different numbers here to illustrate that, at a minimum, they are different copies.

A user may enter commands and information into the computer 2010 through input devices such as a keyboard 2062, a microphone 2063, and a pointing device 2061, such as a mouse, trackball or touch pad. Other input devices (not shown) may include a joystick, game pad, satellite dish, scanner, or the like. These and other input devices are often connected to the processing unit 2020 through a user input interface 2060 that is coupled to the system bus, but may be connected by other interface and bus structures, such as a parallel port, game port or a universal serial bus (USB). A visual display 2091 or other type of display device is also connected to the system bus 2021 via an interface, such as a video interface 2090. In addition to the monitor, computers may also include other peripheral output devices such as speakers 2097 and printer 2096, which may be connected through an output peripheral interface 2095.

The computer 2010 is operated in a networked environment using logical connections to one or more remote computers, such as a remote computer 2080. The remote computer 2080 may be a personal computer, a hand-held device, a server, a router, a network PC, a peer device or other common network node, and typically includes many or all of the elements described above relative to the computer 2010. The logical connections depicted in FIG. 20 include a local area network (LAN) 2071 and a wide area network (WAN) 2073, but may also include other networks. Such networking environments are commonplace in offices, enterprise-wide computer networks, intranets and the Internet.

When used in a LAN networking environment, the computer 2010 is connected to the LAN 2071 through a network interface or adapter 2070. When used in a WAN networking environment, the computer 2010 typically includes a modem 2072 or other means for establishing communications over the WAN 2073, such as the Internet. The modem 2072, which may be internal or external, may be connected to the system bus 2021 via the user input interface 2060, or other appropriate mechanism. In a networked environment, program modules depicted relative to the computer 2010, or portions thereof, may be stored in the remote memory storage device. By way of example, and not limitation, FIG. 14 illustrates remote application programs 2085 as residing on remote computer 2080. It will be appreciated that the network connections shown are exemplary and other means of establishing a communications link between the computers may be used.

Finally, it is worth mentioning that, in one embodiment, the described system and mechanisms for monitoring projected warehouse resource strains or problems are configurable so as to focus on different types of demand and supply. For example, in one embodiment, the user is provided with functionality in the system that enables him/her to exclude certain types of demand data (e.g., like purchase orders, etc.) from being considered in a particular forecast. Thus, the system is particularly flexible and configurable.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented warehouse operations forecasting system, comprising:
a series of user navigable displays hierarchically organized based on level of detail from more general to more detailed in terms of information presented; and
a display in the series that includes an indication of projected warehouse resource utilization over a period of time in the future.

2. The system of claim 1, wherein the display in the series includes an indication of a warehouse construct that represents a plurality of different warehouses.

3. The system of claim 1, wherein the indication of the warehouse construct includes an associated indication of a projected warehouse resource concern.

4. The system of claim 1, wherein the indication of the projected warehouse resource concern is an indication of a projected warehouse space concern.

5. The system of claim 1, wherein the indication of the projected warehouse resource concern is an indication of a projected warehouse resource concern.

6. The system of claim 1, wherein navigating from one of the hierarchically organized displays to another comprises navigating from a displaying with an indication of a warehouse to a display showing one or more transactions scheduled to occur in relation to the warehouse.

7. The system of claim 1, wherein the display includes a warning indicating that the indication of projected warehouse resource utilization may be flawed to do an incomplete data element included in a display in the series other than said display that includes the indication of projected warehouse utilization.

8. The system of claim 1, further comprising a configuration display including a control for selecting a particular one of a plurality of different versions of a data set to be factored into the indication of projected warehouse resource utilization instead of another of the plurality of different versions.

9. The system of claim 1, wherein an enterprise resource planning data set is factored into the indication of projected warehouse resource utilization.

10. A computer implemented warehouse operations forecasting system, comprising:
a data analysis component that receives business data and generates, based at least in part on the business data, a warehouse operations forecast that includes a series of user navigable displays hierarchically organized based on level of detail from more general to more detailed in terms of information presented.

11. The system of claim 10, wherein the warehouse operations forecast is provided on a display so as to include an indication that at least some data for the warehouse operations forecast to be determined complete is missing.

12. The system of claim 10, wherein the series of user navigable displays includes a display showing projected warehouse space utilization over a period of time.

13. The system of claim 10, wherein the series of user navigable displays includes a display showing projected warehouse space utilization across a plurality of different warehouse units.

14. The system of claim 10, wherein the series of user navigable displays includes a display showing projected warehouse human resource utilization over a period of time.

15. The system of claim 10, wherein the series of user navigable displays includes a display showing projected warehouse human resource utilization across a plurality of different warehouses.

16. A computer implemented warehouse operations forecasting system, comprising:
a first user interface for setting parameters in relation to a selected warehouse construct; and
a second user interface that presents a warehouse resource utilization component of a warehouse operations component, the warehouse resource utilization component being programmatically determined based at least in part on one of the parameters set in the first user interface.

17. The system of claim 16, further comprising an indicator in the second user interface that identifies a possible concern related to warehouse space utilization.

18. The system of claim 16, further comprising an indicator in the second user interface that identifies a possible concern related to warehouse human resource utilization.

19. The system of claim 16, wherein the parameters pertain to human work capacity.

20. The system of claim 16, wherein the parameters pertain to product inventory space utilization.
